(19) United States
(12) Patent Application Publication
(10) Pub. No.: US 2006/0016249 A1
(43) Pub. Date: Jan. 26, 2006

(54) Heat recovery test apparatus and method for making and testing the same

(76) Inventor: Lani G. Ache, Plymouth, MN (US)

Correspondence Address: DORSEY & WHITNEY LLP;INTELLECTUAL PROPERTY DEPARTMENT, 50 SOUTH SIXTH STREET, MINNEAPOLIS, MN, 55402-1498, US

(21) Appl. No.: 11/171,484

(22) Filed: Jun. 30, 2005

Related U.S. Application Data
(60) Provisional application No. 60/584,390, filed on Jun. 30, 2004.

(51) Int. Cl. G01M 3/20

(52) U.S. Cl. 73/40.7; 73/46; 29/407.05

(57) ABSTRACT

A test apparatus for testing the tube-to-header connections in a heat recovery system in which a plurality of tubes is connected to a header via tube-to-header connections. The test apparatus includes a source of test gas, a shroud surrounding the tube-to-header connections and a test gas detector in communication with the chamber within the shroud. The invention also relates to a method of testing the tube-to-header connections by forming a test chamber surrounding the tube-to-header connections, introducing a test gas into the chamber and then detecting the level of test gas in the chamber.

### CROSS-REFERENCE TO RELATED APPLICATION

This application claims priority to U.S. Provisional Application No. 60/584,390, filed on Jun. 30, 2004, the contents of which are incorporated herein by reference in its entirety.

### BACKGROUND OF THE INVENTION

1. Field of the Invention

The present invention relates generally to a test apparatus and method and more specifically to a heat recovery test apparatus and system and a method of making and testing such heat recovery apparatus and system.

2. Description of the Prior Art

Heat recovery systems are known in the art. One such heat recovery system is often referred to as a heat recovery steam generator (HRSG). HRSGs typically utilize waste heat from a variety of sources such as a combustion gas turbine or the like and convert the same into steam for reuse. HRSGs typically include a vertical header or manifold and a plurality (in some cases 10 or more to as many as 100 or more) horizontally positioned heat exchange tubes or pipes. These tubes or pipes are connected with the header via tube-to-pipe header connections so that the interior of the tubes or pipes communicate with, or are in flow engagement with, the interior of the header. These tubes are normally connected to the header via welding, brazing or the like. An essential step in the manufacture of an HRSG involves the testing of the tube-to-header connections to ensure that there are no leaks. Although the HRSG headers are normally vertically oriented and the tubes or pipes are horizontally oriented, the orientation of the completed panel is dependent on the gas flow in the final assembly and the orientation of the headers is dependent upon the facility and fabrication sequence. Usually, the tubes and pipes are perpendicular to the headers.

Conventional HRSG tube-to-header testing utilizes a hydrostatic test. This involves filling the HRSG unit or system with water at high pressure and visually observing whether any leaks exist around the tube-to-header connections. If a leak does exist, it is identified and repaired. This normally requires draining the test water from the system, re-welding the defective tube-to-header connection and then repeating the hydrostatic test as described above. Hydrostatic can be, and often is, conducted on the system during fabrication at the manufacturing facility or after installation at the user's site, or both.

Although hydrostatic testing is the conventional and generally accepted method for testing HRSG tube-to-header connections, numerous limitations exist. One disadvantage of hydrostatic testing is that the use of water within the system “wets” the system and often leads to corrosion when the test is completed and the system is exposed to atmospheric conditions. Further, because of the high water pressures (as high as 2,000 psi or more) needed to conduct a satisfactory hydrostatic test, many of the system drains and/or vents need to be welded shut during the test process, and then opened with a cutting torch when the test is completed. This often introduces impurities into the interior of the system. Still further, a hydrostatic testing system requires significant capital expenditure and has limited portability. In many cases, this limits the ability or increases the costs and time to check a leak in an HRSG system located in the field or at its installation site.

Accordingly, there is a need in the art for a heat recovery system test apparatus and a method of making and testing a heat recovery system which overcomes the limitations in the art.

### SUMMARY OF THE INVENTION

The present invention relates to a test apparatus for a heat recovery system and a method for making and testing a heat recovery system which has particular applicability to a heat recovery system commonly referred to as a heat recovery steam generator (HRSG).

The test apparatus and methods in accordance with the present invention eliminates the use of a hydrostatic or water pressure test, thus minimizing or eliminating atmospheric corrosion caused by wetting of the system. Further, the test apparatus and methods in accordance with the present invention function at relatively low pressures, thereby eliminating the need to close vents and/or drains in the header by welding and then reopening the same with cutting torch. Still further, the test apparatus and methods in accordance with the present invention provide a test which is extremely sensitive, is highly portable and requires limited capital expenditure and labor to perform.

In one embodiment of the present invention, the test apparatus includes a shroud or housing which is positionable around a portion of the header and a portion of the heat exchange tubes, a source of hydrogen, helium or other detectable test gas and a means for detecting the presence of such gas. In this embodiment, the shroud is positioned around a portion of the header and a portion of the tubes whose connections are to be tested. Such positioning forms a gas containment or test chamber. A gas test mechanism is positioned at either the bottom end or the top end of the test chamber, depending upon whether the test gas is heavier or lighter than ambient air, to determine the level of test gas, if any, within such chamber. A further component of the test apparatus is a test member for testing an individual tube-to-header connection. This member includes a shroud or housing which substantially surrounds an individual tube-to-header connection and a means in communication with such shroud or housing to detect the existence of a test gas.

The method of testing in accordance with the present invention includes positioning a shroud or housing around a portion of a header and plurality of tube-to-header connections to be tested, introducing hydrogen, helium or some other test gas into the heat recovery system and then testing a sample of air from the interior of the shroud or housing to determine the amount of test gas, if any, within such chamber. If a predetermined level of test gas is detected within the test chamber, it can be concluded that a leak exists and each individual tube-to-header connection (or selected tube-to-header connections) is further tested to isolate the defective tube-to-header connection or connections.

The method of making a heat recovery system in accordance with the present invention includes providing a header having a plurality of openings for connecting heat exchange tubes, connecting a plurality of heat exchange tubes to the header in the area of the plurality of openings via welding, brazing, or the like, and then testing the tube-to-header connections for leaks via the test method described above.

The above features, structural elements and method steps will become more apparent with reference to the drawings, the description of the preferred embodiment and the appended claims.

### DESCRIPTION OF THE DRAWINGS

FIG. 1 is an isometric view of the heat recovery portion of a heat recovery steam generator (HRSG) system.

FIG. 2 is a top, elevational view, with portions broken away, of one of the headers and a portion of the connected tubes of FIG. 1.

FIG. 3 is a top, elevational view, with portions broken away, of a shroud surrounding a portion of one of the headers and a plurality of tubes connected thereto.

FIG. 4 is a side elevational, fragmentary view of a shroud connected with one of the headers and a plurality of tubes extending therefrom.

FIG. 5 is a view, partially in section, as viewed along the section line 5-5 of FIG. 4.

FIG. 6 is a front elevational, fragmentary view of the shroud connected with one of the headers.

FIG. 7 is an isometric, fragmentary view of one side portion of the shroud.

FIG. 8 is a view, partially in section, showing the relationship of the tube engagement seal of the shroud in FIG. 7 relative to a plurality of tubes.

FIG. 9 is an isometric, fragmentary view of a further embodiment of a shroud in accordance with the present invention.

FIG. 10 is a view, partially in section, showing the relationship between a portion of the shroud of FIG. 9 and the plurality of the tubes.

FIG. 11 is a view, partially in section, as viewed along the section line 11-11 of FIG. 5.

FIG. 12 is an isometric view showing connection of an individual tube-to-header connection test member.

FIG. 13 is a view, partially in section, as viewed along the section line 13-13 of FIG. 12.

FIG. 14 is a view, partially in section, as viewed along the section line 14-14 of FIG. 13.

FIG. 15 is a view, similar to that of FIG. 13, showing the test member being connected to the tube to be tested.

FIG. 16 is a schematic view of the test system in accordance with the present invention.

FIG. 17 is a view, partially in section, of a further embodiment of an individual tube-to-header connection test unit as shown being used with a center tube.

FIG. 18 is a view, partially in section, of the individual connection test unit of FIG. 17, but used with an outer tube.

FIG. 19 is an isometric view of the test unit of FIGS. 17 and 18.

FIG. 20 is an elevational view of a further embodiment of a shroud assembly with the top part removed.

FIG. 21 is a view, partially in section, as viewed along the section lines 21-21 of FIG. 20.

FIG. 22 is an elevational top view showing the pair of side panels of the shroud assembly of FIG. 20.

FIG. 23 is an elevational side view showing one of the side panels and the tube engaging edge thereof.

FIG. 24 is an elevational rear view of the tube engaging bladder of the shroud assembly of FIG. 20.

FIG. 25 is an elevational top view of the bladder shown in FIG. 24.

FIG. 26 is a view, partially in section, as viewed along the section line 26-26 of FIG. 24.

### DESCRIPTION OF THE PREFERRED EMBODIMENT AND METHOD

The present invention is directed to a test apparatus for a heat recovery system and a method of making and testing a heat recovery system. More specifically, the invention is directed to a test apparatus for a heat exchanger portion of a heat recovery system and a method of making and testing such heat exchanger portion. Although the present invention is useful for a variety of heat recovery systems with different structures, it has particular applicability to a heat recovery system commonly referred to as a heat recovery steam generator (HRSG) and in particular a heat exchange component or panel of such HRSG. Accordingly, the description of the preferred embodiment and methods will be described with reference to an HRSG.

With reference to FIG. 1, an HRSG system typically includes one or more heat recovery or heat exchange units or panels 10. Each of these units 10 includes a pair of headers or manifolds 11,11 and an array or plurality of tubes 12 extending between the headers 11,11. When the units 10 are installed and when the units 10 are tested during fabrication, these headers 11,11 are generally vertically positioned, with the array of tubes 12 extending horizontally between the headers 11,11. The headers 11,11 have a hollow interior and closed ends. As known in the art, an HRSG system may be installed as a panelized design in which the panels 10 are individually installed, as a module design in which modules comprised of two or more panels are installed as a unit and C-panel design in which panels are supported and installed as part of a generally C-shaped frame structure.

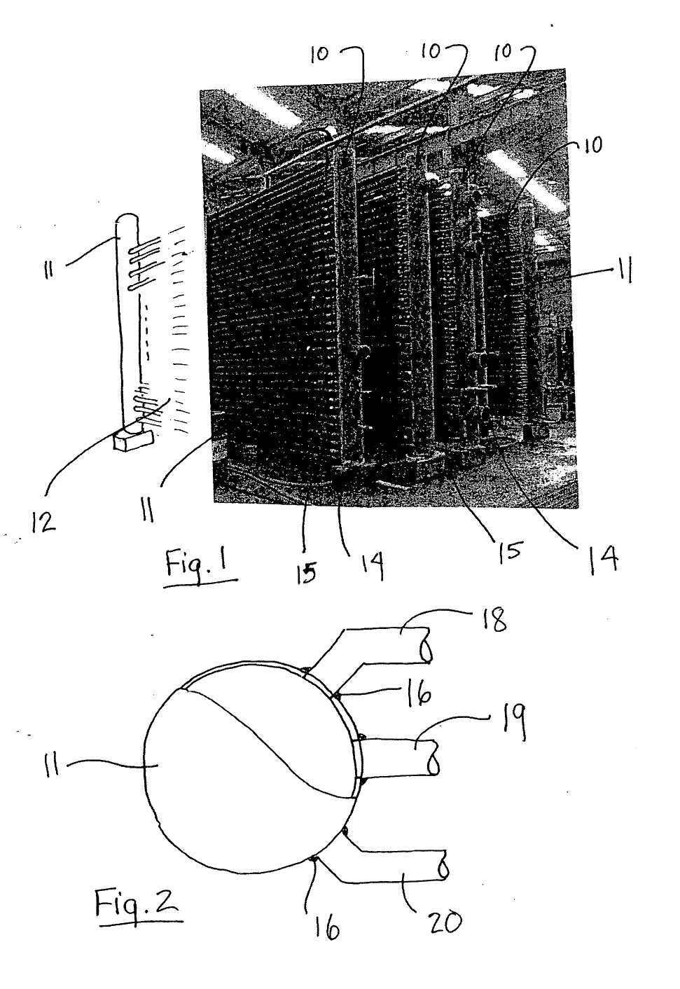

As shown in FIG. 2, the individual tubes 18, 19, 20 within the array of tubes 12 are connected to openings in the walls of the headers 11,11 via welding, brazing or the like 16 so that the hollow interior of the tubes are in communication with the hollow interior of the headers. During use, a heat exchange (or cooling) fluid or medium flows through the tubes 18, 19, 20 from one header 11 to the other 11 and from one unit 10 to the other 10, if desired. The tubes within the array 12 may include a series of laterally spaced tubes 18, 19 and 20 in a horizontal plane or a series of tubes or tube clusters which are staggered from one another.

One step in the manufacture or fabrication of a heat exchange or recovery unit or panel 10, such as that shown in FIG. 1, or after the installation of the panel and before use, involves the testing of the tube-to-header connections between the individual tubes in the array 12 to the headers 11 to ensure that the connections are tight and no leaks exist.

Each of the headers 11 may include one or more vents 14 or drains 15. Further, each of the units 10, if desired, may embody flow conduits to facilitate flow of the heat exchange or cooling medium between adjacent units 10. At least one of the units 10 within each heat recovery system also includes a heat exchange or cooling medium inlet and a heat exchange or cooling medium outlet.

Reference is next made to FIGS. 3, 4, 5, 6 and 7 showing various views or portions of a test shroud or housing 21 connected with a portion of the header 11 and a portion of the tubes in the area of the tube-to-header connections being tested. As will be described below, the shroud 21 forms a test chamber or test gas flow chamber 17 surrounding the tube-to-header connections to be tested. The shroud 21 includes a pair of side walls 22 and 24, a pair of top wall sections 23 and 25 and a pair of front wall sections 26 and 27. Each of the side walls 22 and 24 is an elongated structure having a length which preferably at least approximates the height of the header 11. Each of the side walls 22, 24 includes a header seal 30 and a tube seal 31. As shown best in FIGS. 5 and 6, the header seal 30 is formed on an inner surface portion along the front edge 28 of each side wall 22 and 24 and extends substantially the entire length of the side walls 22 and 24. When assembled for use, the header seal 30 engages an outer surface portion of the header 11 as shown in FIGS. 5 and 6.

The tube seal 31 is formed on an inner surface of the rearward edge 29 of each of the side walls 22 and 24 and extends substantially the entire length of the side walls 22 and 24. During use, the tube seal 31 engages surface portions of each of the outer tubes 18 and 20 as shown in FIGS. 3, 5 and 8.

The seals 30 and 31 can be constructed of a variety of seal materials. In the preferred embodiment, however, the seals 30 and 31 are constructed of a soft rubber or rubber-type synthetic material. The side walls 22 and 24 may also be constructed from a variety of materials such as various metals and plastics. In the preferred embodiment, however, the side walls 22 and 24 are constructed of sheet metal.

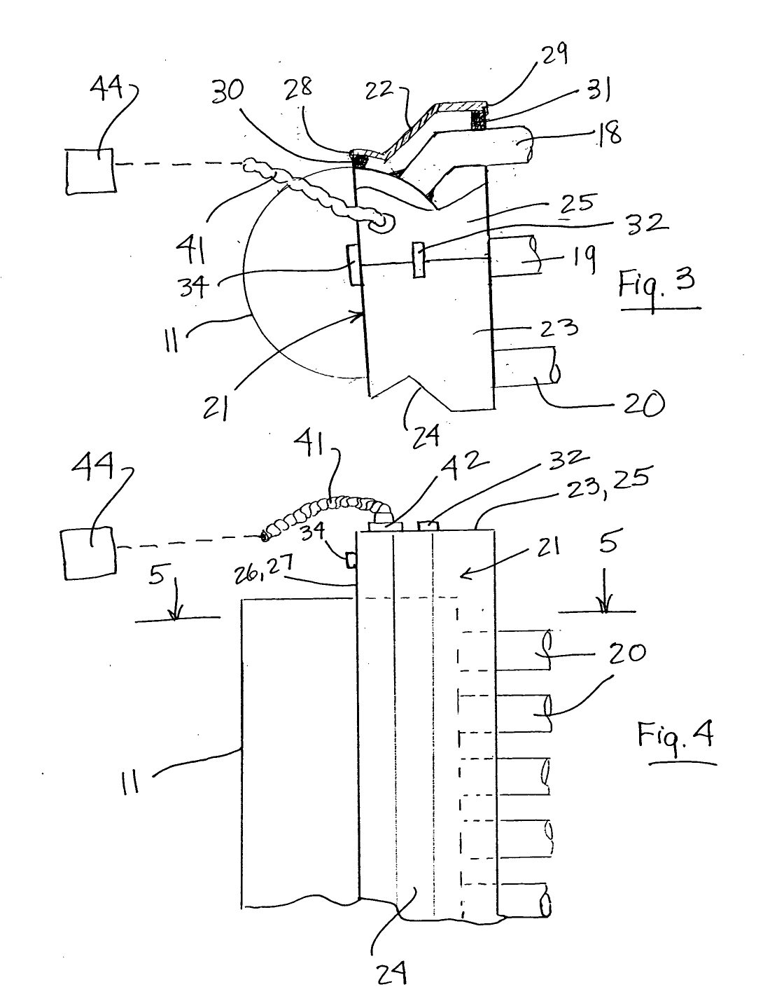

The top portion of the shroud 21 includes the top wall sections 23 and 25 (FIGS. 3 and 4) and the front wall sections 26 and 27 (FIGS. 4 and 6). The top wall section 25 is connected with the side wall 22 along the top edge of the side wall 22 and the top wall section 23 is connected with the side wall 22 along the top edge of the side wall 24. When the shroud 21 is connected with the header 11 and tube array 12, the tube wall sections 23 and 25 are joined to one another by a latch member 32.

With reference to FIG. 6, the front wall section 27 is connected with an upper portion of the side wall 22 along its front edge 28 and a portion of the top wall section 25. The front wall section 26 is connected with an upper portion of the side wall 24 along its front edge 28 and a portion of the top wall section 23. As shown, the inner edges of the front wall sections 26 and 27 are intended to be joined together and retained in that position by a latch member 34. When the shroud 21 is in its assembled form and ready for use, the bottom edges of the wall sections 26 and 27 rest on or engage the top surface of the header 11. If desired, the upper portion of the shroud 21 can be provided with similar rear wall sections (not shown) which are also connected with a latch member and which assist in defining and isolating the test chamber 17 within the shroud 21.

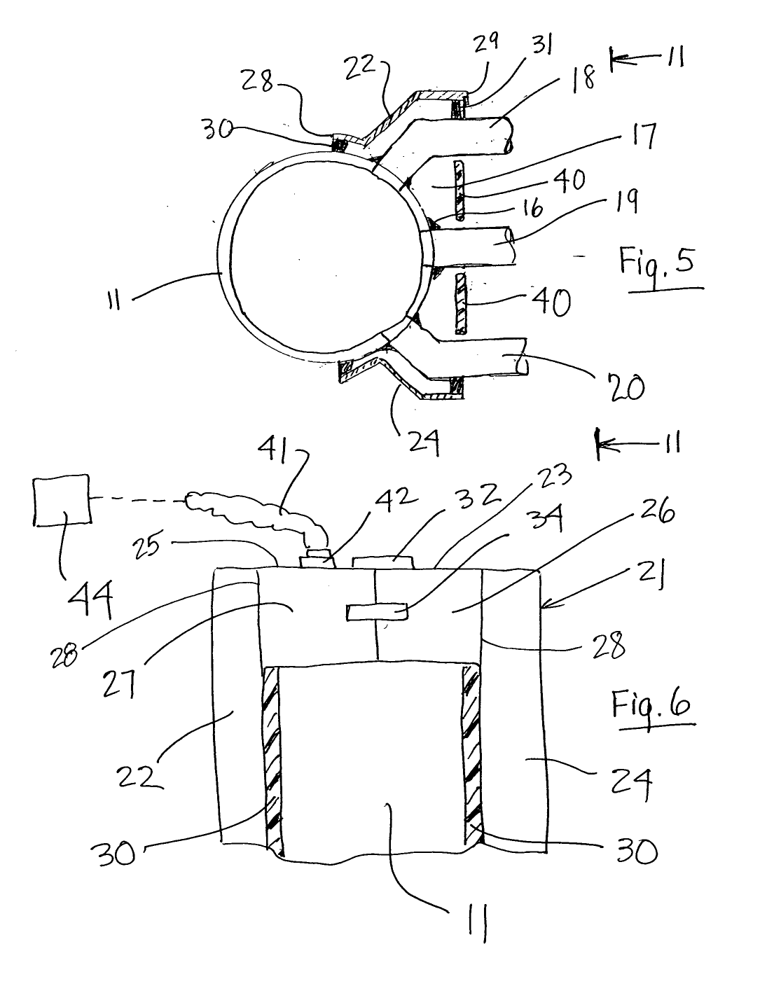

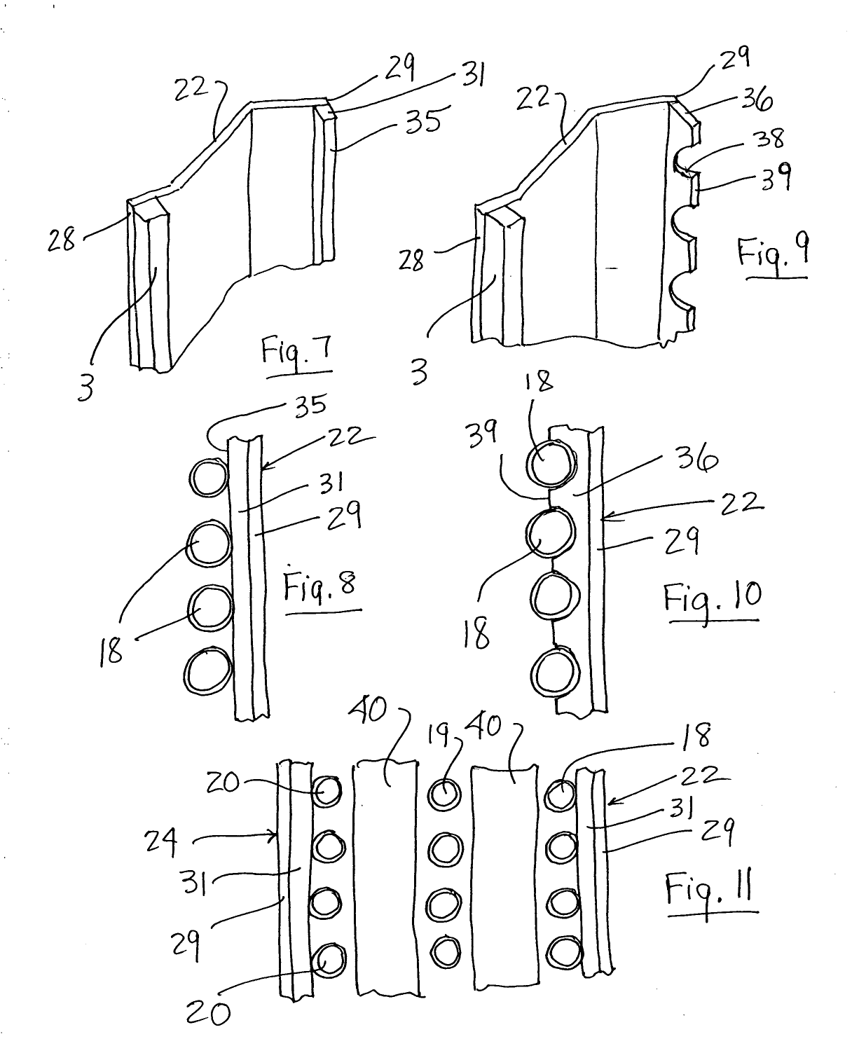

One embodiment of the tube seal member 31 is shown in FIGS. 7 and 8. In this embodiment, the tube seal member 31 comprises an elongated seal member 31 having an inner seal edge 35 for engaging a peripheral surface portion of the outer tubes 18 and 20 in the tube array 12 of FIGS. 2, 3 and 5. A further embodiment of a tube seal member is illustrated in FIGS. 9 and 10 by the reference character 36. This seal member 36 includes a plurality of concave portions with a seal edge 38 for engagement with a peripheral portion of the outer tubes 18 and 20 and an intermediate portion 39 which extends at least partially between adjacent outer tubes 18 and adjacent outer tubes 20.

If desired, and as shown best in FIGS. 5 and 11, the area or space between the outer tubes 18 and 20 and the inner tube 19 may be partially sealed by a pair of hanging seal members 40. Such seal members 40 extend from near the upper end of the shroud 21 to the lower or bottom end of the shroud 21, and are positioned between the tubes 18 and 19 and between the tubes 19, 20. If provided, these hanging seals 40 are flexible so that they can be rolled up when not in use or allowed to hang as shown best in FIG. 11 when in use. When in use, the hanging seal members 40 assist in defining the test chamber 17.

It should be noted that the header seals 30 do not need to form a perfect airtight seal with the side walls of the header 11, nor do the tube seals 31 need to form a perfect airtight seal with the outer tubes 18 and 20. Further, the shroud may or may not include the hanging seals 40. As discussed below, this all depends on the specific test gas being used, the amount of the test gas which occurs naturally in the ambient atmosphere and the sensitivity of the testing apparatus for such test gas. If the test gas is the preferred test gas hydrogen or helium which can be detected and measured at extremely low concentrations and is naturally present in the ambient atmosphere at a lever where a deviation from that level can be readily detected, the hanging seal members 40 can be eliminated, if desired. All that is needed is for the shroud to roughly define a test chamber 17 which will confine at least a portion of the test gas (assuming a leak) and allow it to rise to the top of the shroud 21 for detection.

As shown best in FIGS. 3, 4 and 6, the top wall section 25 is provided with a test gas detection tube 41 which is connected to the wall section 25 via the fitting 42. The tube 41 extends to and is connected to a test instrument 44 which is capable of detecting the presence of the test gas in a quantity that would indicate a leak in one of the tube-to-header connections. When the preferred test gas is hydrogen or a diluted form of hydrogen such as a non-flammable combination of hydrogen and nitrogen, the test instrument 44 may be any one of a variety of available microelectric hydrogen sensors. When the preferred test gas is helium (He₂), the test instrument 44 is a mass spectrometer which is capable of detecting the presence of helium in amounts as little as 1×10⁻⁶ cc/second leak rate. By providing the interior of the header 11 and tubes 12 with test gas at a pressure of about 15 psig or more, a leak in one of the tube-to-header connections will provide test gas at the test instrument well in excess of the level that can be readily detected, thus providing a means for detecting leaks.

The test apparatus in accordance with the present invention also includes the individual tube-to-header connection test unit shown in FIGS. 12-15. This unit is used if a leak is detected in one or more of the tube-to-header connections. Such unit includes the individual connection test shroud 45. The shroud 45 is a collar-type structure which, when assembled, comprises a generally cylindrical configuration having a cylindrical outer wall portion 46 and an annular wall portion 48 which are connected with one another at the corner 49. The end of the cylindrical wall portion 46 opposite to the corner 49 includes a header seal 50 while the edge of the annular wall portion 48 opposite to the corner 49 includes a tube seal 51. As shown best in FIG. 15, the test member 45 is hinged at the point 52 to allow the test member 45 to be positioned around one of the tubes 18, 19, 20 when being tested, and to be removed when the testing is complete. When in use, the shroud 45 forms a test chamber 47 around an individual tube-to-header connection.

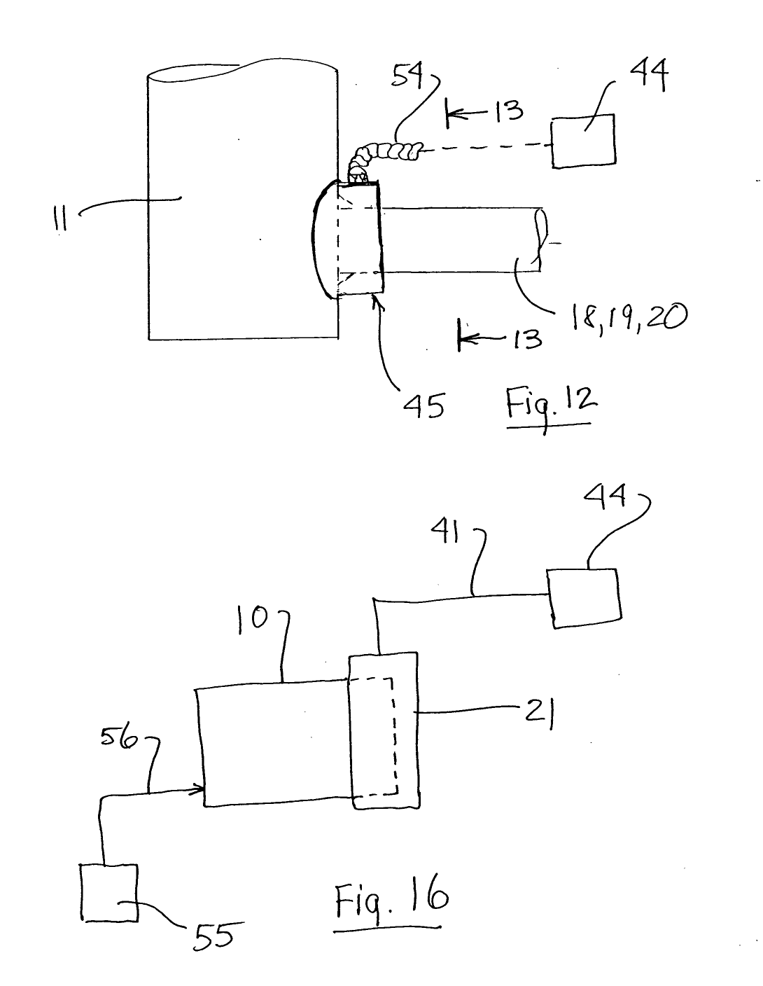

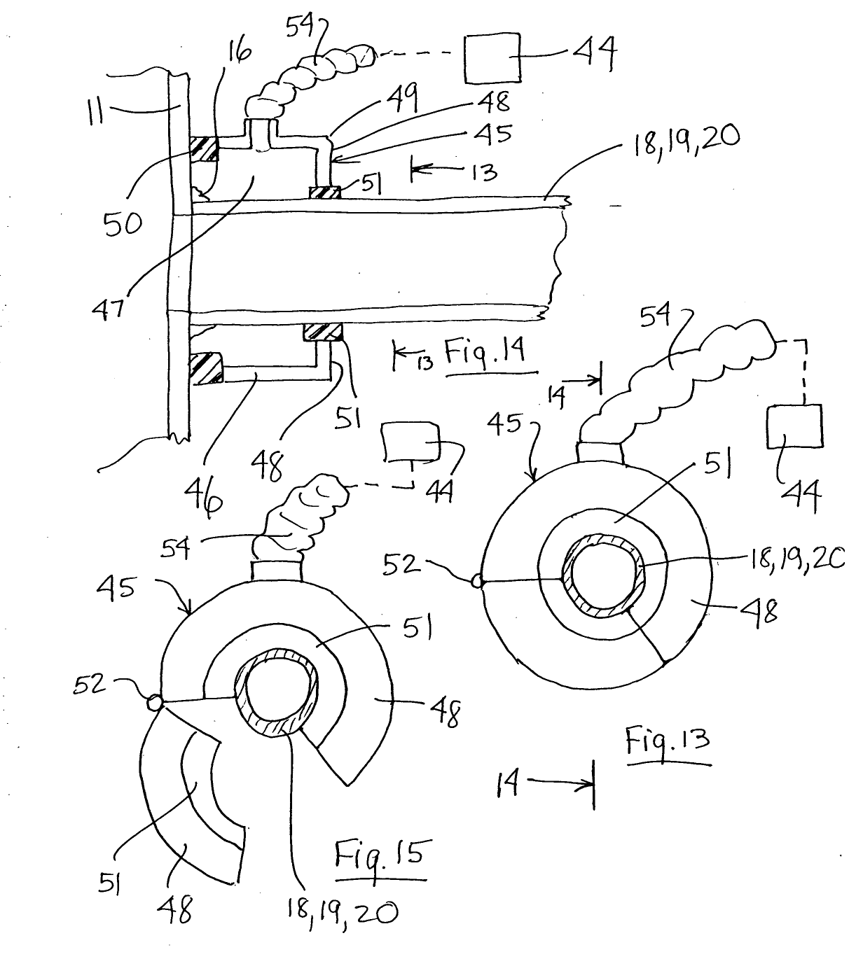

A top portion of the cylindrical wall 46 is provided with a test gas detection tube 54 which is in communication with the chamber 47. The opposite end of this tube 54 is connected with a test instrument 44 such as a microelectronic hydrogen sensor, a mass spectrometer or other gas test instrument as described above. To use the test member 45, the cylinder wall 46 is opened along the hinge 52, as shown in FIG. 15, positioned around the tube to be tested, and then closed and pressed against the header 11 as shown in FIGS. 13 and 14. In this position, the header seal 50 engages the outer surface of the header 11 in the area adjacent to the tube connection and the tube seal 51 engages the outer surface of the tube 18, 19, 20. If no test gas is detected after a predetermined period of time, which should be at least 10 minutes, it can be concluded that the tested tube-to-header connection is leak free and the test member 46 is moved to another tube-to-header connection site. This process is repeated until all connections have been tested or until the defective connection or connections have been located.

The use of the test apparatus of the present invention and the method aspect of the present invention can be described as follows. First, the shroud 21 is positioned around a portion of the header and tube array connections which are to be tested. The test gas is then introduced into the header and tube array at a pressure which is sufficient to pass through a leak in a tube-to-header connection if such a leak exists and to provide a sufficient amount of test gas to be detected. With hydrogen, helium (He₂) or diluted forms thereof as the test gas, the heat exchange system is pressurized with the test gas to a pressure of about 15 psig or more and maintained at that pressure for a period of time which is sufficient to allow the test gas to enter the interior of the header and the entire tube array and, if there is a leak in one or more of the tube-to-header connections, pass through such leak, flow to the top of the shroud 21, through the tube 42 and to the test instrument 44. For this occur, the test gas should be maintained at the above pressure for at least about 10 minutes.

If there is a leak at one of the tube-to-header connections, the test gas (preferably hydrogen or helium) will flow through the leak and, because both of such gases are lighter than atmospheric air, will rise to the top of the shroud 21 and enter the tube 42. If needed or desired, a low level vacuum can be applied to the tube 44 to assist in moving the air within the test chamber to the top of the test chamber and through the tube 42 to the test instrument 44. If a sufficient quantity of the test gas (greater than that present in ambient atmosphere) is detected by the test instrument 44 to indicate a leak in one or more of the tube-to-header connections, a process is initiated to isolate and identify the particular tube-to-header connection or connections which leak. This process involves using the individual tube-to-header connection shroud 45 of FIGS. 12-15 to test each of the individual tube-to-header connections. An apparatus can also be used, if desired, for testing groups (more than one) of tube-to-header connections such as groups of connections in a lateral or vertical row. Such an apparatus would have a shroud or housing that substantially isolates the group of connections so that any leak in such group can be detected.

Alternatively, to assist in isolating the defective tube-to-header connection, the individual test member 45 (or the inlet end of the gas detection tube 54) can be positioned within the test chamber at a location between the bottom and top of the shroud 21. If no test gas is detected after a predetermined period of time at that position, it can be concluded, that the leak does not exist below that point because the preferred test gases (hydrogen or helium) are lighter than air and will rise from the leak. This process can be repeated to narrow the number of individual connections which must be checked.

Accordingly, one method in accordance with the present invention is a method for testing a heat recovery system, and more particularly a heat exchange portion of an HRSG (for leaks). This method includes defining a test chamber by positioning a shroud 21 around a portion of the header and tube array to be tested, or otherwise isolating an exterior portion of the header and tube array to be tested. A test gas such as hydrogen or helium is then introduced into the HRSG panel or system at a preselected pressure and for a preselected period of time which will result in the test gas entering the test chamber if a leak exists in one of the tube-to-header connections. A test gas detection instrument, such as a microelectronic hydrogen sensor or a mass spectrometer, is provided to determine whether test gas exists in the test chamber at a sufficient level to indicate a leak. If it does not, it can be concluded that there is no leak. If a leak is detected, each individual tube-to-header connection, or group of tube-to-header connections (within the test area), is individually checked by continuing the introduction of test gas into the system and determining whether the amount of test gas at that connection or at that group of connections, is sufficient to indicate a leak. This is done by using the apparatus of FIGS. 12-15 to define a test chamber around an individual tube-to-header connection or a similar apparatus to define a test chamber around a group of tube-to-header connections. If no leak is detected at a particular tube-to-header connection or group of tube-to-header connections, the process is repeated for each tube-to-header connection or group of tube-to-header connections. If a leak is detected, the defective tube-to-header connection is re-welded or otherwise repaired and the repaired connection, and preferably also the entire panel or system, is retested.

The method of making a heat recovery system and in particular a heat exchange component for a HRSG includes providing a header 11 having a plurality of holes for connection of a plurality of tubes, welding or otherwise connecting a plurality of tubes to such plurality of holes and testing the tube-to-header connections for leaks via the above-described method.

FIG. 16 is a schematic diagram showing the present invention. In FIG. 16, a source of test gas such as hydrogen, helium or a diluted form thereof is delivered from the reservoir or test gas container 55 via the conduit 56 to an inlet of the heat exchange unit or component 10 whose connections are to be tested. The shroud 21 is positioned over a portion of the unit 10 including the header and a portion of the tube-to-header connections to define a test chamber and the test gas is introduced into the unit 10. Air within the test chamber defined by the shroud 21 is directed through the conduit or line 41 to the test device 44. In the preferred embodiment, the test device 44 is a microelectronic hydrogen sensor or a mass spectrometer.

FIGS. 17, 18 and 19 show a further embodiment of an individual test member 60 for forming a sealed relationship relative to one of the horizontal tubes 18, 19 or 20, and the header 11 and for defining a test chamber 64. In this embodiment, the test member 60 is comprised of a relatively flexible, rubber or rubber-type cup-shaped member 61 having an edge 65 for engagement with an exterior surface of the horizontal tube 18, 19 or 20 and an opposite edge 66 for engagement with an exterior surface of the header 11. Preferably, the edge 66 has an edge configuration which conforms to the generally cylindrical exterior surface of the header 11.

As shown, the member 61 is a generally cup-shaped member having a side wall and a slot in such wall which extends from the edge 65 to the edge 66 and which is defined by the edges 68,68. This permits the member 61 to be opened up and slipped over one of the tubes 18, 19 or 20 whose connection to the header 11 is to be tested. Specifically, after being positioned over one of the tubes 18, 19 or 20, the two edges 68 are held together manually or via a clamp or connection member and the edges 65 and 66 are held against the exterior surfaces of the tubes 18, 19 or 20 and header 11, respectively. The side wall of the member 61 includes a tube through which the air within the chamber 64 can be directed to a test instrument 44 (as previously described) and tested. As shown in FIGS. 17 and 18, the member 61 is sufficiently flexible and pliable so that its configuration can be altered to accommodate either one of the center tubes 19 (FIG. 17) or one of the outer tubes 18,20 (FIG. 18).

To use the test member 60, a test gas is introduced into the system, i.e., the tubes and header, and the air within the chamber 64 is tested to determine whether any test gas is detected.

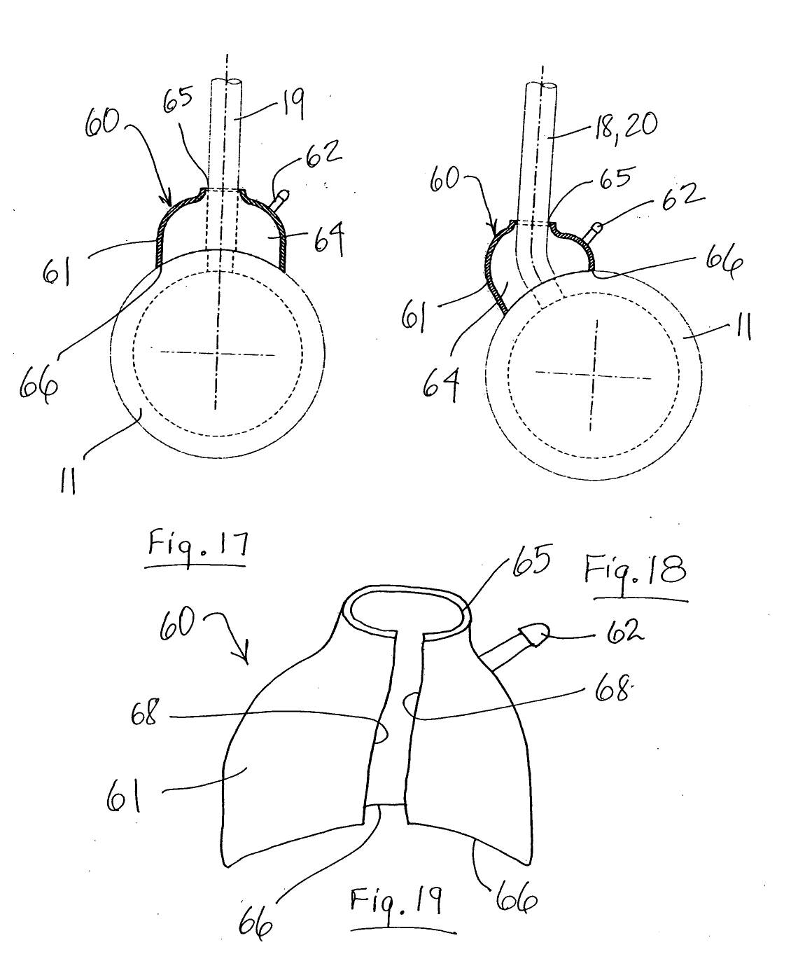

Reference is next made generally to FIGS. 20-26 showing a further embodiment of a shroud assembly for multiple tube-to-header connections, with more specific reference to FIG. 20. FIG. 20 is an elevational view of this further shroud assembly as viewed from the top, with the top or end panel removed. This assembly includes a pair of side panels 69 and 70, a bladder 71 and a plurality of bungee cords 72, 74 or other similar devices for retaining the shroud assembly in operational position relative to the header 11 and the tubes 18, 19 and 20.

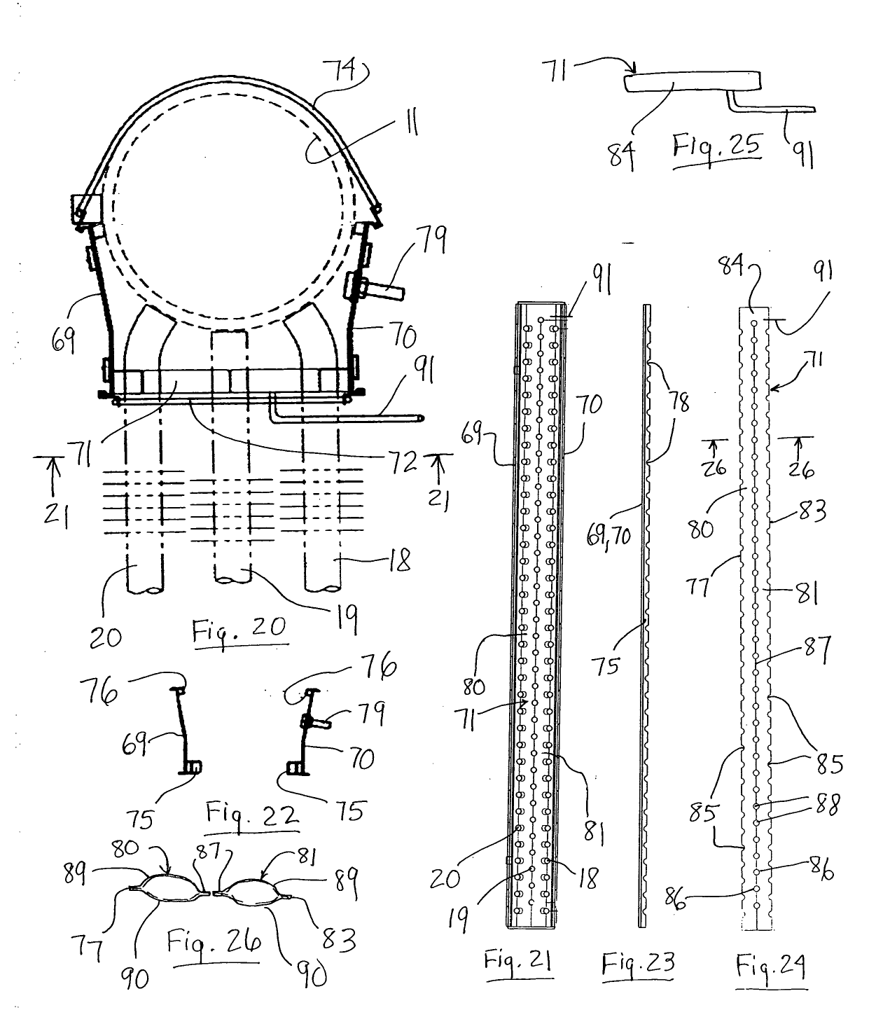

With continuing reference to FIG. 20 and further reference to FIG. 22, each of the side panels 69 and 70 includes a soft seal member 75 extending along the entirety of one of its edges for engagement with a portion of the outer tubes 18 and 20. A soft seal member 76 also extends along the entirety of the other edge of each of the side panels 69 and 70 for engagement with the outer surface of the header 11. Preferably, both of the seal members 75 and 76 are soft seal members constructed of a rubber, rubber-type or foam material to conform in a substantial engaging relationship relative to the tubes 18 and 20 and the surface of the header 11. As shown in FIG. 23, the seal members 75 have concave or scalloped portions 78 (similar to that shown in FIGS. 9 and 10) for engagement with a greater portion of the exterior surfaces of the tubes 18 and 20. In this embodiment, a test gas sample tube 79 is provided in the side panel 70 near the top. This tube 79 is connected with a test instrument 44 of the type described above.

As shown best in FIG. 20, the side panels 69 and 70 are connected with the header 11 and with the tubes 18, 19 and 20 by a series of bungee cords 72 and 74. One end of each of the bungee cords 74 is connected with an edge portion of the side panel 69 in the area of the seal 76, with the other end of the bungee cord extending around the exterior of the header 11 as shown and being connected to the other side panel in the area of the seal 76. A plurality of these bungee cords 74 are spaced vertically along the header 11 and the side panels 69 and 70.

One end of each of the bungee cords 72 is connected with an edge portion of the side panel 69 in the area of the seal 75, with the other end extending past the tubes 18, 19 and 20 and being connected to the edge of the other side panel 70 in the area of the seal 75. As with bungee cord 74, a plurality of these bungee cords 72 are spaced vertically along the tubes 18, 19 and 20 and the side panels 69 and 70.

With continuing reference to FIG. 20 and additional reference to FIGS. 24, 25 and 26, the bladder structure 71 is more specifically shown. As shown, the bladder 71 includes a pair of elongated side portions 80 and 81 which are adjacent to one another along their inner edges 87 and which are connected at their tops in the area 84. Each of the outer edges 77 and 83 of the sides 80 and 81 is provided with a plurality of concave or scalloped portions 85 and are designed to engage an inwardly facing surface portion of the tubes 18 and 20. Thus, the spacing between the portions 85 correspond to the vertical spacing between the outer tubes 18 and the outer tubes 20. Further, as shown best in FIG. 21, the outer edge portions of the sides 80 and 81 between the concave portions 85 are designed to extend a limited distance between the tubes 18 and 20 and preferably engage corresponding portions of the seal members 75 between the concave portions 78 (FIG. 23).

The inner edges 87 of each of the sides 80 and 81 is also provided with a plurality of concave portions 86. These portions 86 are configured and spaced so that they match up or mate with each other, thereby forming the generally circular openings 88 when positioned next to one another. As shown in FIG. 21, these openings 88 are designed to fit around the centrally positioned tubes 19.

The lower ends of the sides 80 and 81 are disconnected from one another to permit the sides 80 and 81 to be inserted between the vertical rows of tubes 20 and 19 and between the vertical rows of tubes 18 and 19, respectively. This is done by inserting the lower ends of the sides 80 and 81 between the vertical tube sets from the top of a panel to be tested.

As shown in FIG. 26 comprised of a cross-section of the bladder 71, the bladder 71 is comprised of a pair of bladder walls 89 and 90 which are joined together and sealed at their outer edges 77 and 83 and at their inner edges 87. These sealed and joined edges 77, 83 and 87 follow the configuration of the edges 77, 83 and 87 shown in FIG. 24, including the concave portions 85 and the concave portions 86.

The bladder 71 is also provided with a filling tube 91 into which air or other fluid can be introduced. This enables the bladder 71 to be selectively inflated so as to further press the sides 80 and 81, and in particular the concave portions 85 and 86, into engagement with the surfaces of the tubes 18 and 20 and the tubes 19, respectively. When installed, the sides 80 and 81 are positioned between the set of tubes 20 and 19 and the set of tubes 19 and 18 in a collapsed or deflated state. Then after installed, air is introduced into the bladder 71 through the tube 91. This causes engagement between the edges of the sides 80 and 81 and the respective tubes.

Although the description of the preferred embodiment has been quite specific, it is contemplated that various modifications could be made without deviating from the spirit of the present invention. Accordingly, it is intended that the scope of the present invention be dictated by the appended claims rather than by the description of the preferred embodiment.

1. A test apparatus for testing the tube-to-header connections in a heat recovery system of the type having a header and a plurality of tubes connected to the header via such tube-to-header connections, the test apparatus comprising:
a source of test gas;
a shroud positionable relative to a portion of the header and a selected number of the tubes to define a test gas chamber at least partially surrounding the tube-to-header connections of the selected tubes;
a test gas detector in communication with said shroud.

2. The test apparatus of claim 1 wherein said test gas one of hydrogen or helium.

3. The test apparatus of claim 2 wherein the header is vertically oriented and said test gas detector is in communication with said shroud near its top end.

4. The test apparatus of claim 3 wherein said test gas detection is a mass spectrometer.

5. The test apparatus of claim 4 wherein said heat recovery system is a heat recovery steam generator.

6. The test apparatus of claim 1 wherein said heat recovery system is a heat recovery steam generator.

7. A method of testing the tube-to-header connections in a recovery system of the type having a header and a plurality of tubes connected to the header via tube-to-header connections, the method comprising:
forming a first test chamber at least partially surrounding a first selected group of the tube-to-header connections;
introducing a test gas into the header and the plurality of tubes of the heat recovery system; and
detecting the level of test gas, if any, within said first test chamber.

8. The method of claim 7 wherein said forming step includes positioning a shroud relative to a portion of the header and the selected group of tubes.

9. The method of claim 7 wherein the test gas is one of hydrogen and helium.

10. The method of claim 9 including maintaining the test gas in the header and tubes for a preselected period of time prior to said detecting step.

11. The method of claim 9 including maintaining the test gas in the header and tubes at a pressure of at least about 15 psig.

12. The method of claim 7 including determining whether a predetermined level of test gas in said first test chamber is detected and if it is, forming a second test chamber at least partially surrounding a second selected group of tube-to-header connections or an individual tube-to-header connection within said first selected group.

13. The method of claim 12 including detecting the level of test gas in said second test chamber.

14. A method of making a heat exchange component for a heat recovery system comprising:
providing a header with a plurality of tube receiving openings;
providing a plurality of tubes;
connecting a tube to each said tube receiving openings via a tube-to-header connection;
positioning the header and the connected tubes so that the header is vertically oriented; and
testing the tube-to-header connections by:
forming a test gas chamber surrounding a selected number of said tube-to-header connections;
introducing a test gas into the header and plurality of tubes of the heat recovery system; and
detecting the level of test gas within said test chamber.

15. The method of claim 14 wherein said heat recovery system is a heat recovery steam generator.

16. The method of claim 14 wherein said test gas is one of hydrogen or helium.

17. A method of testing a heat recovery system having a header and a plurality of tubes connected to the header via tube-to-header connections, the method comprising:
isolating at least a portion of the header and a portion of the tube-to-header connections to be tested to define a test chamber;
introducing a test gas into the header and plurality of tubes; and
testing a sample of the air within said test chamber to determine the level of test gas within said test chamber.

18. The method of claim 17 wherein said test gas is one of hydrogen or helium.

19. The method of claim 18 wherein said test gas is introduced into said header and said tubes and maintained therein at a preselected pressure and for a preselected time prior to said testing step.

20. The method of claim 19 including testing the air within said test chamber using a mass spectrometer.
